(19) United States
(12) Patent Application Publication
(10) Pub. No.: US 2019/0233442 A1
(43) Pub. Date: Aug. 1, 2019

(54) SELECTIVE ESTROGEN RECEPTOR DOWN-REGULATORS (SERDS)

(71) Applicant: Xavier University of Louisiana, New Orleans, LA (US)

(72) Inventors: Guangdi WANG, New Orleans, LA (US); Jiawang LIU, New Orleans, LA (US); Shilong ZHENG, New Orleans, LA (US); Qui ZHONG, Metairie, LA (US); Shanchun GUO, Tucker, GA (US)

(21) Appl. No.: 16/317,196

(22) PCT Filed: May 5, 2017
(86) PCT No.: PCT/US2017/031297

§ 371 Date: Jan. 11, 2019

Related U.S. Application Data
(60) Provisional application No. 62/332,541, filed on May 6, 2016.

(51) Int. Cl. C07F 5/02

(52) U.S. Cl. CPC C07F 5/025

(57) ABSTRACT

The present disclosure relates to orally bioavailable selective estrogen receptor down-regulators (SERDs) and the synthesis of the same. Further, the present disclosure teaches the utilization of the orally bioavailable selective estrogen receptor down-regulators (SERDs) in a treatment for proliferative diseases, including cancer, particularly breast cancer, and especially ER+ breast cancer.

### BACKGROUND

### 1. Field

The present disclosure relates to orally bioavailable selective estrogen receptor down-regulators (SERDs), and methods for making the same. The disclosure also relates to pharmaceutical compositions comprising these SERDs, and methods for using the same for treatment of estrogen receptor mediated pathological developments, including cancers.

The SERDs described here can provide effective endocrine therapy for breast cancers that express estrogen receptor (estrogen receptor positive or “ER+” breast cancers) as the first line adjuvant treatment regimen, or in the second-line setting as treatment for patients with disease progression after prior endocrine therapy such as selective estrogen receptor modulators (SERMs) and aromatase inhibitors (AIs).

### 2. Description of Related Art

Breast cancer remains the most common cancer in women worldwide, with over 1.7 million new cases diagnosed in 2012 (second most common cancer overall). This represents about 12% of all new cancer cases and 25% of all cancers in women. Nearly 80% of breast cancer cases are estrogen receptor positive (ER+) [1, 2] and for the majority of these patients, endocrine therapy is an appropriate option both the adjuvant and advanced setting. Current endocrine therapy for ER+ breast cancer comprises three regimen options that can be used in varied sequences for optimal outcome: SERM (e.g., tamoxifen, raloxifene, toremifene), aromatase inhibitors (AIs, including anastrozole, exemestane, letrozole), and SERD (fulvestrant) [3]. Tamoxifen is a first-line agent for pre-menopausal patients and for women requiring secondary chemoprevention after a DCIS diagnosis. In postmenopausal women AIs are generally preferred to tamoxifen because of more favorable time to progression and less severe side effects [4, 5]. However, most patients with advanced metastatic breast cancer eventually develop resistance to tamoxifen or AI treatment while retaining the expression of ERα in the recurrent and/or progressive disease. This clinical information provides a viable therapeutic rationale for using fulvestrant to which most of the AI- or tamoxifen-resistant breast cancers are not cross-resistant. Indeed, fulvestrant has proven to be a very effective SERD, and is currently the only FDA approved therapy for breast cancer progressing after SERM or AI treatments [6, 7]. Unfortunately, fulvestrant has very poor bioavailability if administered orally, thus its standard route of administration is intramuscular (i.m.) injection, which takes 3-4 months to reach steady state serum concentration and has negatively impacted its widespread use [8]. Moreover, even at a recently approved higher dose of 500 mg, the peak blood concentration of fulvestrant remains below a modest 25 ng/mL in the FINDER1 and FINDER2 clinical trials [9, 10], suggesting that its optimal efficacy in patients may not have been achieved [7]. In addition, it still takes 1 month to reach steady state fulvestrant concentration in patient plasma [7]. The promising clinical utility of fulvestrant and the increasing understanding of its mechanism of action have motivated the development of SERDs with greater bioavailability and efficacy [11, 12].

Thus, in an embodiment, the SERDs of the present disclosure are compounds of the formula (I):

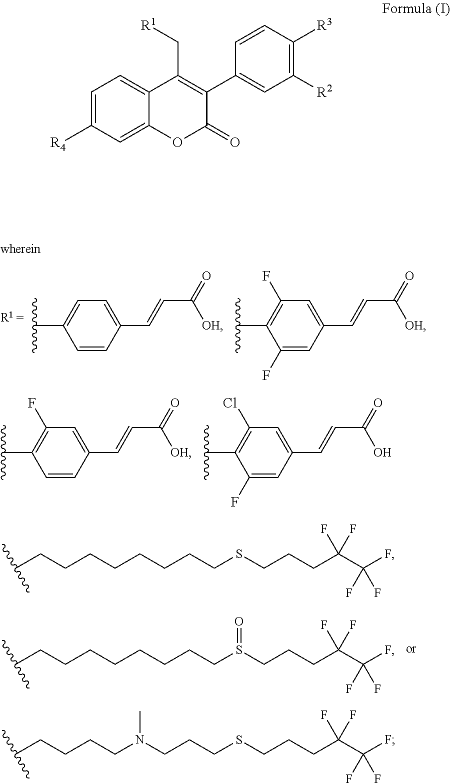

R²=H, OH, Me, Cl, F, or CF₃;
R³=H, OH, OMe, F, CF₃, OCF₃, Cl, Br, (HO)₂B, KF₃B, NaF₃B,

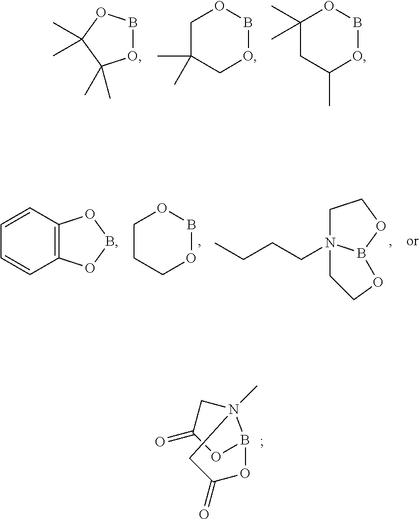

and
R⁴=H, OH, OMe, F, CF₃, OCF₃, Cl, Br, (HO)₂B, KF₃B, NaF₃B,

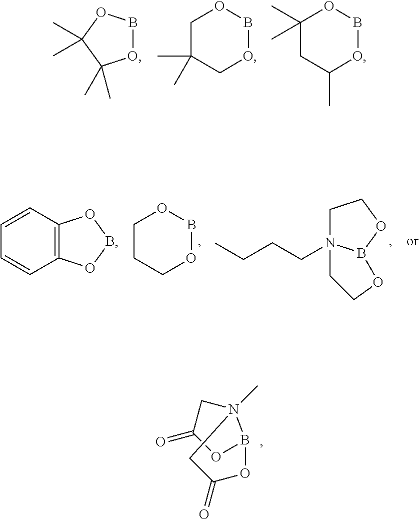

wherein the R³ substituent point of attachment is on the substituent boron atom of R³, and the R⁴ substituent point of attachment is on the substituent boron atom of R⁴, as depicted more fully by the example SERD structures provided below. An example of a SERD of Formula (I) is SERD 1, and the general synthetic scheme for synthesizing SERDs of Formula (I) is shown in FIG. 1.

In another embodiment, the SERDs of the present disclosure are compounds of the formula (II):

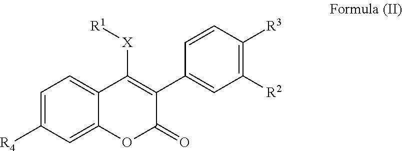

wherein
X=O, S, NH, OCH₂, SCH₂, NHCH₂, CH₂O, CH₂S, or CH₂NH₂

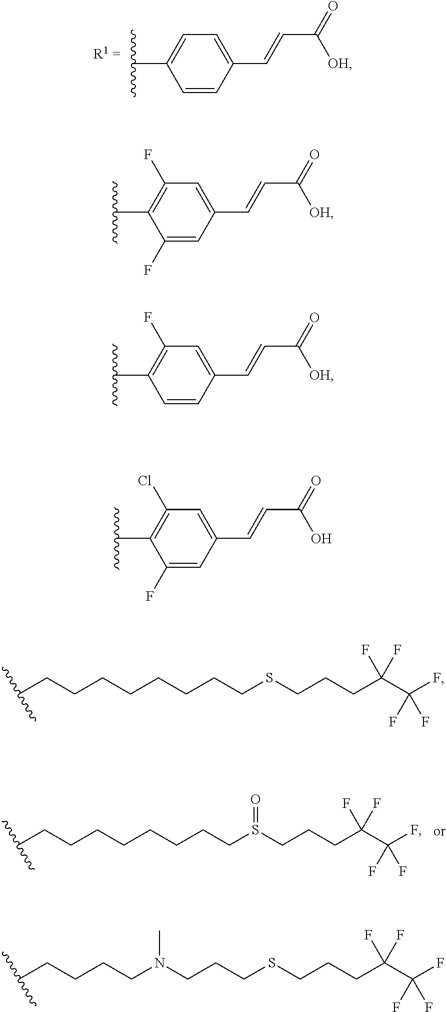

R²=H, OH, Me, Cl, F, or CF₃;
R³=H, OH, OMe, F, CF₃, OCF₃, Cl, Br, (HO)₂B, KF₃B, NaF₃B,

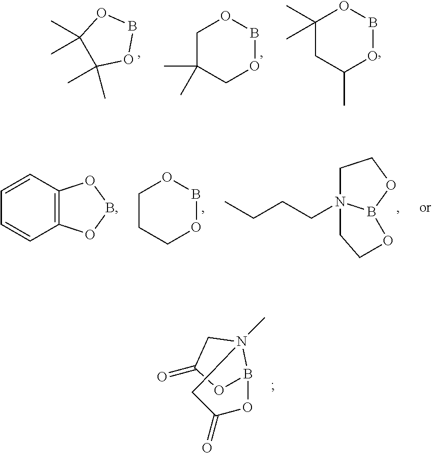

and
R⁴=H, OH, OMe, F, CF₃, OCF₃, Cl, Br, (HO)₂B, KF₃B, NaF₃B,

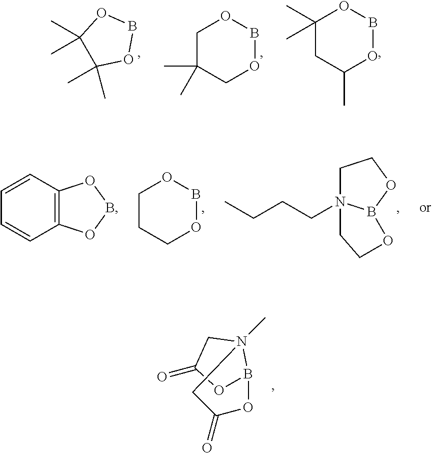

Wherein the R³ substituent point of attachment is on the substituent boron atom of R³, and the R⁴ substituent point of attachment is on the substituent boron atom of R⁴, as depicted more fully by the example SERD structures provided below. An example of a SERD of Formula (II) is SERD 2, and the general synthetic scheme for synthesizing SERDs of Formula (II) is shown in FIG. 2.

In another embodiment, the SERDs of the present disclosure are compounds of the formula (II)

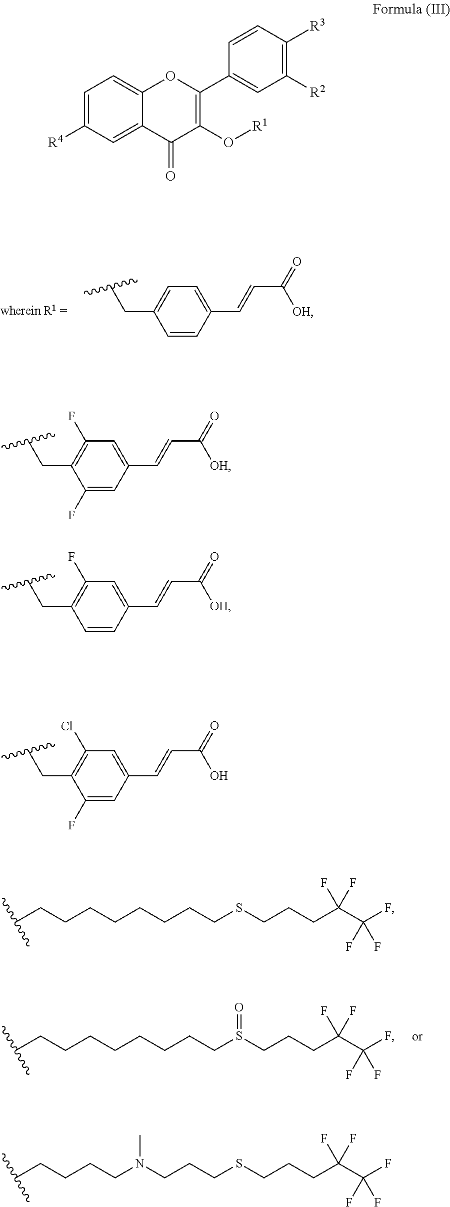

R²=H, OH, Me, Cl, F, or CF₃;
R³=H, OH, OMe, F, CF₃, OCF₃, Cl, Br, (HO)₂B, KF₃B, NaF₃B,

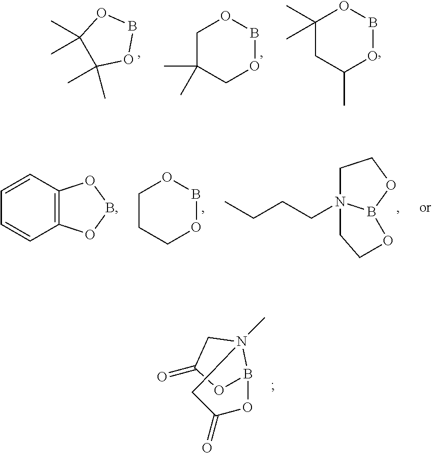

and
R⁴=H, OH, OMe, F, CF₃, OCF₃, Cl, Br, (HO)₂B, KF₃B, NaF₃B,

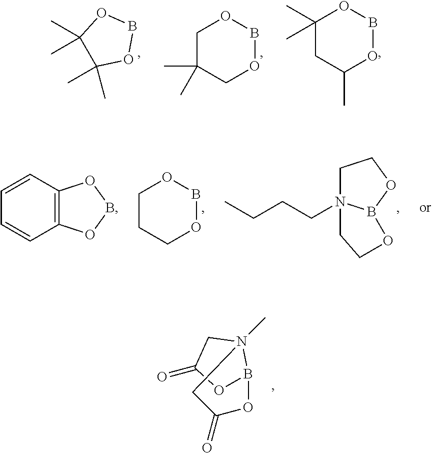

Wherein the R³ substituent point of attachment is on the substituent boron atom of R³, and the R⁴ substituent point of attachment is on the substituent boron atom of R⁴, as depicted more fully by the example SERD structures provided below. An example of a SERD of Formula (III) is SERD 3, and the general synthetic scheme for synthesizing SERDs of Formula (III) is shown in FIG. 3.

In another embodiment, the SERDs of the present disclosure are compounds of the formula (IV)

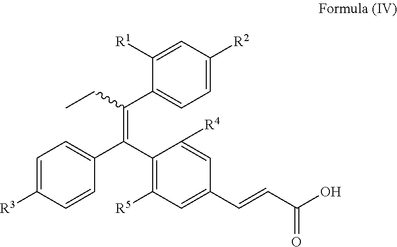

wherein
R¹=H, OH, OMe, Me, Cl, F, or CF₃;
R²=H, OH, OMe, Me, Cl, F, or CF₃;
R⁴=H, F, or Cl;
R⁵=H, F, or Cl; and
R³=H, OH, OMe, F, CF₃, OCF₃, Cl, Br, (HO)₂B, KF₃B, NaF₃B,

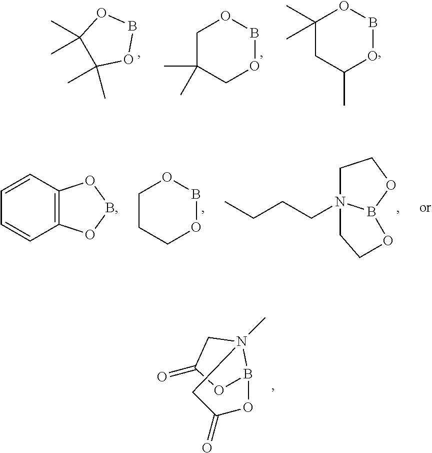

Wherein the R³ substituent point of attachment is on the substituent boron atom of R₃, as depicted more fully by the example SERD strictures provided below. An example of a SERD of Formula (IV) is SERD 4, and the general synthetic scheme for synthesizing SERDs of Formula (IV) is shown in FIG. 4.

In another embodiment, the SERDs of the present disclosure are compounds of the formula (V)

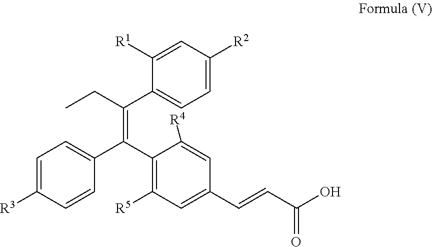

wherein
R¹=H, OH, OMe, Me, Cl, F, or CF₃;
R²=H, OH, OMe, Me, Cl, F, or CF₃;
R⁴=H, F, or Cl;
R⁵=H, F, or Cl; and
R³=H, OH, OMe, F, CF₃, OCF₃, Cl, Br, (HO)₂B, KF₃B, NaF₃B,

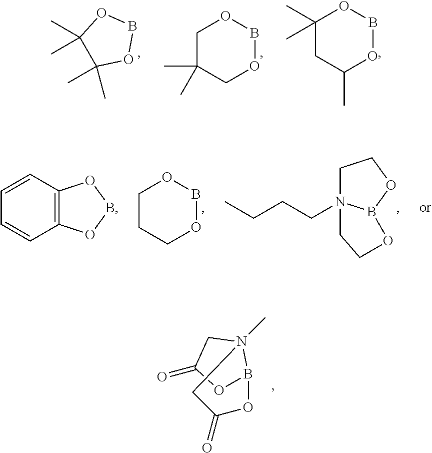

Wherein the R³ substituent point of attachment is on the substituent boron atom of R³, as depicted more fully by the example SERD structures provided below. An example of a SERD of Formula (V) is SERD 5, and the general synthetic scheme for synthesizing SERDs of Formula (V) is shown in FIG. 5.

In another embodiment, the SERDs of the present disclosure are compounds of the formula (VI)

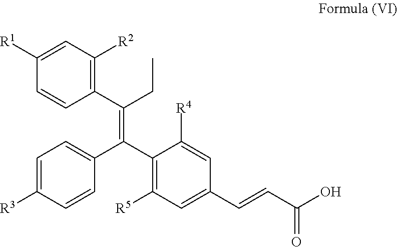

wherein
R¹=H, OH, OMe, Me, Cl, F, or CF₃;
R²=H, OH, OMe, Me, Cl, F, or CF₃;
R⁴=H, F, or Cl;
R⁵=H, F, or Cl; and
R³=H, OH, OMe, F, CF₃, OCF₃, Cl, Br, (HO)₂B, KF₃B, NaF₃B,

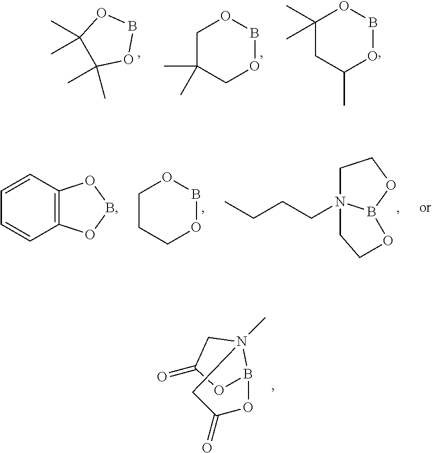

Wherein the R³ substituent point of attachment is on the substituent boron atom of R³, as depicted more fully by the example SERD structures provided below. An example of a SERD of Formula (VI) is SERD 6, and the general synthetic scheme for synthesizing SERDs of Formula (VI) is shown in FIG. 6.

In another embodiment, the SERDs of the present disclosure are compounds of the formula (VII)

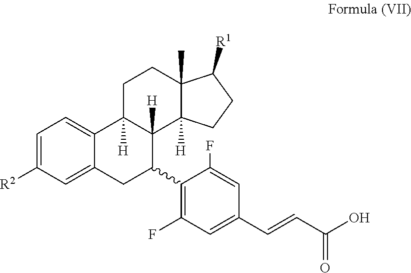

wherein

R¹=H, OH, OMe, F, CF₃, OCF₃, Cl, Br, (HO)₂B, KF₃B, NaF₃B,

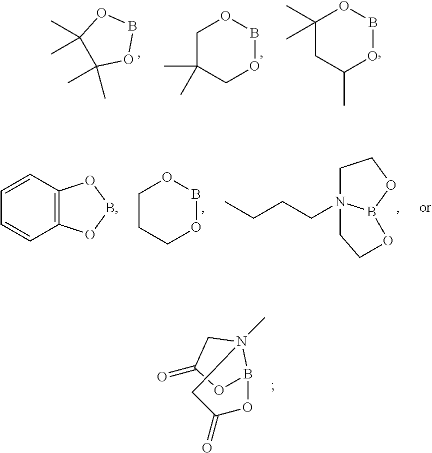

and
R²=H, OH, OMe, F, CF₃, OCF₃, Cl, Br, (HO)₂B, KF₃B, NaF₃B,

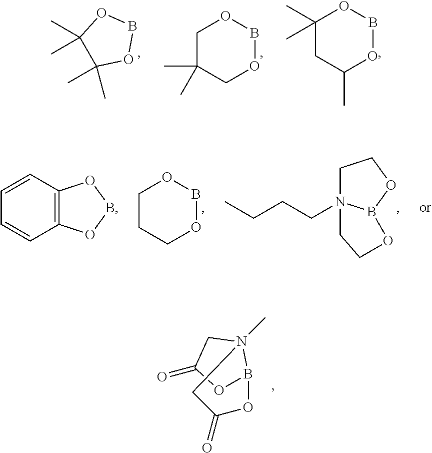

Wherein the R¹ substituent point of attachment is on the substituent boron atom of R¹, and the R² substituent point of attachment is on the substituent boron atom of R², as depicted more fully by the example SERD structures provided below. An example of a SERD of Formula (VII) is SERD 7, and the general synthetic scheme for synthesizing SERDs of Formula (VII) is shown in FIG. 7.

In another embodiment, the SERDs of the present disclosure are compounds of the formula (VIII)

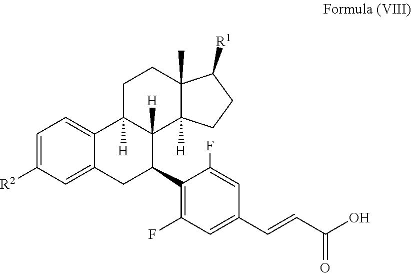

wherein
R¹=H, OH, OMe, F, CF₃, OCF₃, Cl, Br, (HO)₂B, KF₃B, NaF₃B,

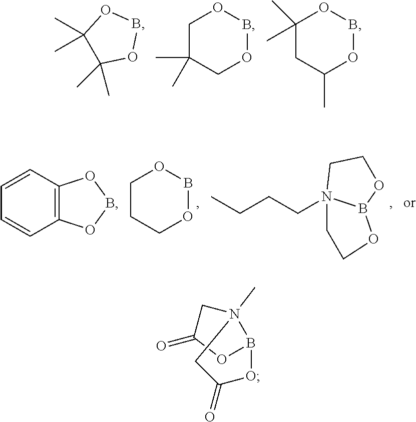

and
R²=H, OH, OMe, F, CF₃, OCF₃, Cl, Br, (HO)₂B, KF₃B, NaF₃B,

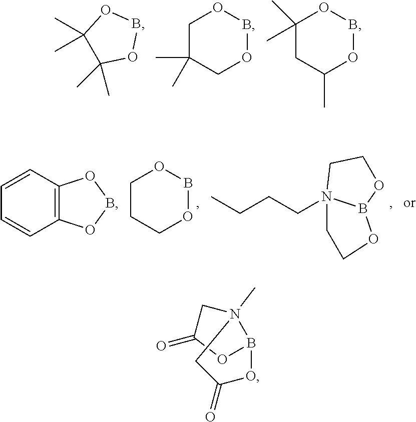

Wherein the R¹ substituent point of attachment is on the substituent boron atom of R¹, and the R² substituent point of attachment is on the substituent boron atom of R², as depicted more fully by the example SERD structures provided below. An example of a SERD of Formula (VIII) is SERD 8, and the general synthetic scheme for synthesizing SERDs of Formula (VIII) is shown in FIG. 8.

In another embodiment, the SERDs of the present disclosure are compounds of the formula (IX)

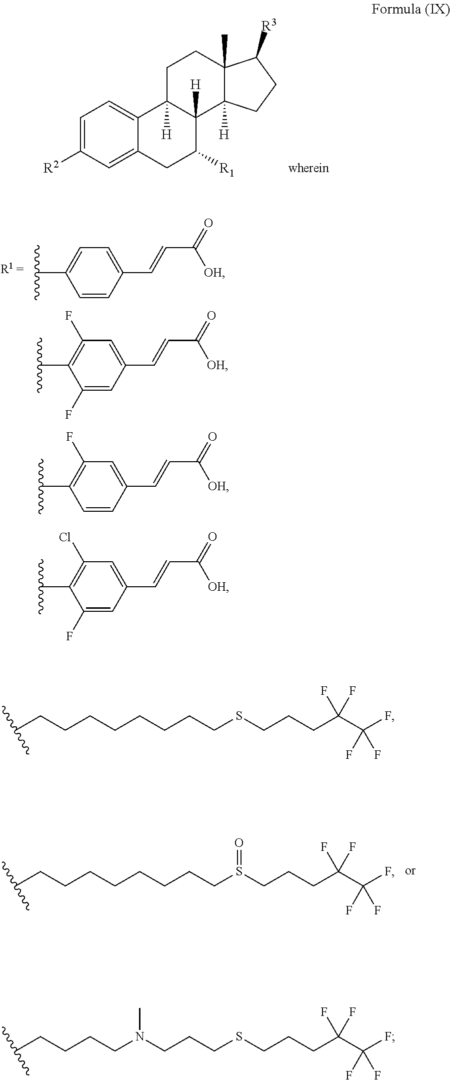

R²=H, OH, OMe, F, CF₃, OCF₃, Cl, Br, (HO)₂B, KF₃B, NaF₃B,

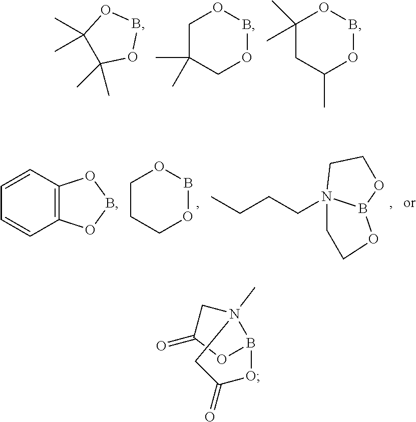

and
R³=H, OH, OMe, F, CF₃, OCF₃, Cl, Br, (HO)₂B, KF₃B, NaF₃B,

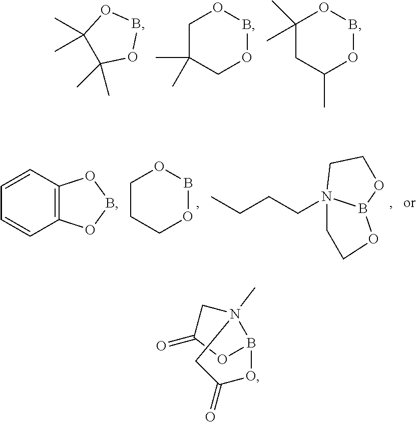

Wherein the R² substituent point of attachment is on the substituent boron atom of R², and the R³ substituent point of attachment is on the substituent boron atom of R³, as depicted more fully by the example SERD structures provided below. An example of a SERD of Formula (IX) is SERD 9, and the general synthetic scheme for synthesizing SERDs of Formula (IX) is shown in FIG. 9.

In another embodiment, the SERDs of the present disclosure are compounds of the formula (X)

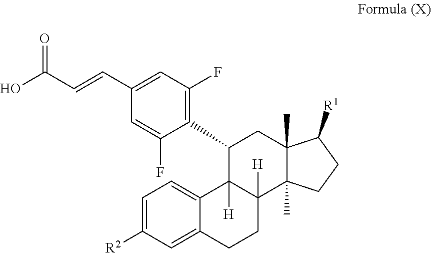

wherein
R¹=H, OH, OMe, F, CF₃, OCF₃, Cl, Br, (HO)₂B, KF₃B, NaF₃B,

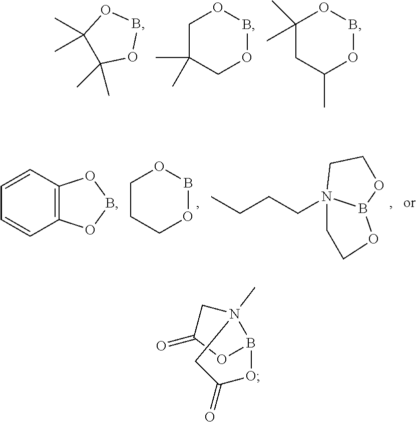

and
R²=H, OH, OMe, F, CF₃, OCF₃, Cl, Br, (HO)₂B, KF₃B, NaF₃B,

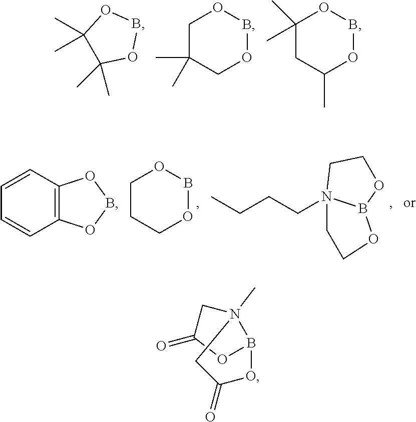

Wherein the R¹ substituent point of attachment is on the substituent boron atom of R¹, and the R² substituent point of attachment is on the substituent boron atom of R², as depicted more fully by the example SERD structures provided below. An example of a SERD of Formula (X) is SERD 10, and the general synthetic scheme for synthesizing SERDs of Formula (X) is shown in FIG. 10.

In a preferred embodiment, the SERD is a compound of formula (I) having the following structure, and denoted SERD 1 (see also FIG. 1):

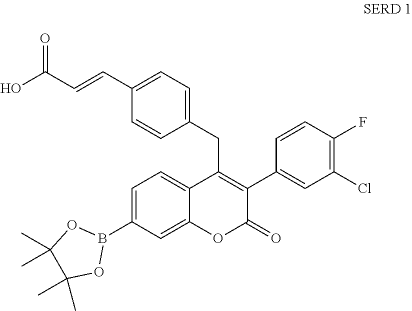 [SMILES: CC1(C)OB(c2ccc3c(Cc4ccc(/C=C/C(=O)O)cc4)c(-c4ccc(F)c(Cl)c4)c(=O)oc3c2)OC1(C)C]

In a preferred embodiment, the oral SERD is a compound of formula (II) having the following structure, and denoted SERD 2 (see also FIG. 2):

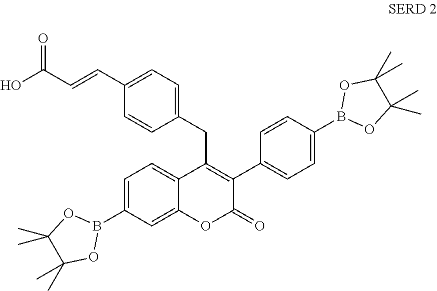 [SMILES: CC1(C)OB(c2ccc(-c3c(Cc4ccc(/C=C/C(=O)O)cc4)c4ccc(B5OC(C)(C)C(C)(C)O5)cc4oc3=O)cc2)OC1(C)C]

In a preferred embodiment, the oral SERD is a compound of formula (III) having the following structure, and denoted SERD 3 (see also FIG. 3):

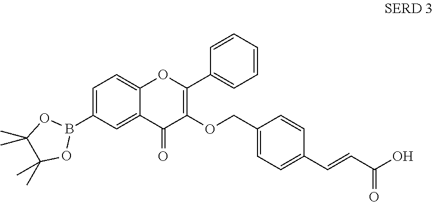 [SMILES: CC1(C)OB(c2ccc3oc(-c4ccccc4)c(OCc4ccc(/C=C/C(=O)O)cc4)c(=O)c3c2)OC1(C)C]

In a preferred embodiment, the oral SERD is a compound of formula (IV) having the following structure, and denoted SERD 4 (see also FIG. 4):

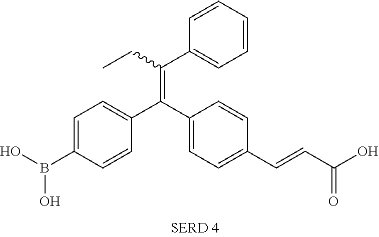 [SMILES: CCC(=C(c1ccc(/C=C/C(=O)O)cc1)c1ccc(B(O)O)cc1)c1ccccc1]

In a preferred embodiment, the oral SERD is a compound of formula (V) having the following structure, and denoted SERD 5 (see also FIG. 5):

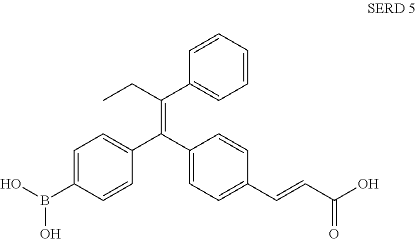 [SMILES: CC/C(=C(/c1ccc(/C=C/C(=O)O)cc1)c1ccc(B(O)O)cc1)c1ccccc1]

In a preferred embodiment, the oral SERD is a compound of formula (VI) having the following structure, and denoted SERD 6 (see also FIG. 6):

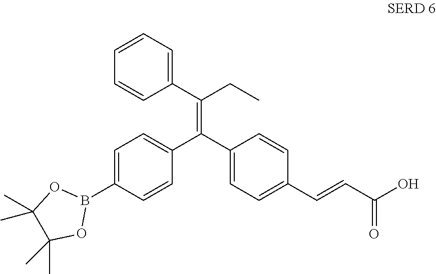 [SMILES: CC/C(=C(\c1ccc(/C=C/C(=O)O)cc1)c1ccc(B2OC(C)(C)C(C)(C)O2)cc1)c1ccccc1]

In a preferred embodiment, the oral SERD is a compound of formula (VII) having the following structure, and denoted SERD 7 (see also FIG. 7):

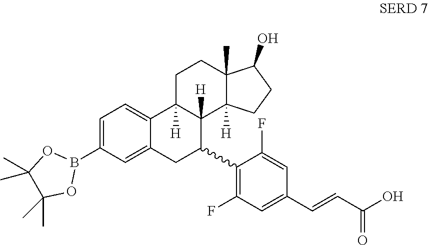

In a preferred embodiment, the oral SERD is a compound of formula (VIII) having the following structure, and denoted SERD 8 (see also FIG. 8):

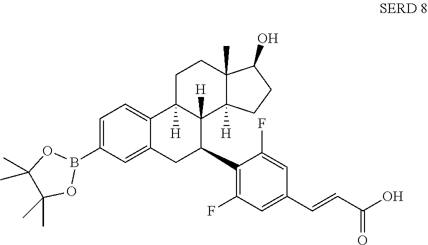

In a preferred embodiment, the oral SERD is a compound of formula (IX) having the following structure, and denoted SERD 9 (see also FIG. 9):

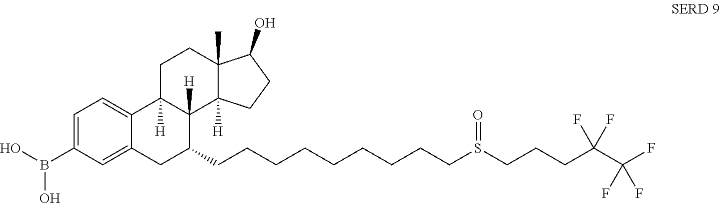

In a preferred embodiment, the oral SERD is a compound of formula (X) having the following structure, and denoted SERD 10 (see also FIG. 10):

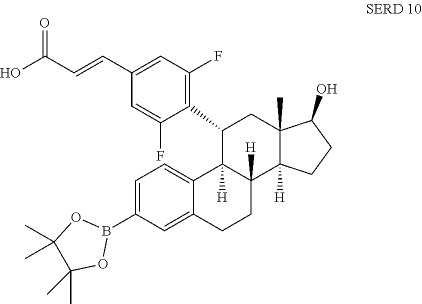

In an embodiment, the disclosure provides for a pharmaceutical composition in the form of at least one SERD for treatment of proliferative diseases, including cancer, and in particular breast cancer, that can obtain clinical benefits from SERD therapy. The composition may comprise at least one SERD in an amount that is therapeutically effective.

The disclosure therefore relates to use of a SERD according to any one of Formulas I through X, or combinations thereof, for treatment and prevention of proliferative diseases including cancer that can derive clinical benefits from such use.

The pharmaceutical compositions of the present disclosure can be in any form known to those of skill in the art. For instance, in some embodiments the pharmaceutical compositions are in a form of a product for oral delivery, said product form being selected from a group consisting of a concentrate, dried powder, liquid, capsule, pellet, and pill. In other embodiments, the pharmaceutical compositions of the disclosure are in the form of a product for parenteral administration including intravenous, intradermal, intramuscular, and subcutaneous administration. The pharmaceutical compositions disclosed herein may also further comprise carriers, binders, diluents, and excipients.

Also, in other aspects, the present disclosure relates to new SERD compounds and their pharmaceutically acceptable salts; pharmaceutical compositions comprising the new SERD compounds, either alone or in combination with at least one additional therapeutic agent, with a pharmaceutically acceptable carrier; and uses of the new SERD compounds, either alone or in combination with at least one additional therapeutic agent, in the treatment of proliferative diseases including breast cancer at any stage of the disease diagnosis. The combination with an additional therapeutic agent may take the form of combining the new SERD compounds with any known therapeutic agent.

Salts of the compounds according to the disclosure include all inorganic and organic salts, especially all pharmaceutically acceptable inorganic and organic salts, particularly all pharmaceutically acceptable inorganic and organic salts customarily used in pharmacy.

One aspect of the disclosure is salts of the compounds according to the disclosure including all inorganic and organic salts, especially all pharmaceutically acceptable inorganic and organic salts, particularly all pharmaceutically acceptable inorganic and organic salts customarily used in pharmacy.

Examples of salts include, but are not limited to, lithium, sodium, potassium, calcium, aluminum, magnesium, titanium, meglumine, ammonium, salts optionally derived from NH₃ or organic amines having from 1 to 16 C-atoms such as, e.g., ethylamine, diethylamine, triethylamine, ethyldiisopropylamine, monoethanolamine, diethanolamine, triethanolamine, dicyclohexylamine, dimethylaminoethanol, procaine, dibenzylamine, N-methylmorpholine, arginine, lysine, ethylendiamine, N-methylpiperindine and guanidinium salts.

The salts include water-insoluble and, particularly, water-soluble salts.

According to the person skilled in the art the compounds of formulas (I) through (X) according to this disclosure as well as their salts may contain, e.g., when isolated in crystalline form, varying amounts of solvents. Included within the scope of the disclosure are therefore all solvates and in particular all hydrates of the compounds of formulas (I) through (X) according to this disclosure as well as all solvates and in particular all hydrates of the salts of the compounds of formulas (I) through (X) according to this disclosure.

The compounds according to the disclosure and their salts can exist in the form of tautomers which are included in the embodiments of the disclosure.

The compounds of the disclosure may, depending on their structure, exist in different stereoisomeric forms. These forms include configurational isomers or optically conformational isomers (enantiomers and/or diastereoisomers including those of atropisomers). The present disclosure therefore includes enantiomers, diastereoisomers as well as mixtures thereof. From those mixtures of enantiomers and/or disastereoisomers pure stereoisomeric forms can be isolated with methods known in the art, preferably methods of chromatography, especially high pressure liquid chromatography (HPLC) using achiral or chiral phase. The disclosure further includes all mixtures of the stereoisomers mentioned above independent of the ratio, including the racemates.

The compounds of the disclosure may, depending on their structure, exist in various stable isotopic forms. These forms include those in which one or more hydrogen atoms have been replaced with deuterium atoms, those in which one or more nitrogen atoms have been replaced with ¹⁵N atoms, or those in which one or more atoms of carbon, fluorine, chlorine, bromine, sulfur, or oxygen have been replaced by the stable isotope of the respective, original atoms.

Some of the compounds and salts according to the disclosure may exist in different crystalline forms (polymorphs) which are within the scope of the disclosure.

It is a further object of the disclosure to provide SERD compounds, methods of synthesizing the SERD compounds, methods of manufacturing the SERD compounds, and methods of using the SERD compounds.

Another object of the disclosure is to provide a composition, for example a pharmaceutical composition, comprising at least one SERD compound in an amount effective for the indication of proliferative diseases such as cancer, including but not limited to endocrine related cancer, for treatment and prevention of recurrence.

A further object of the disclosure is a kit, comprising a composition containing at least one SERD for treatment and prevention of cancer and cancer related morbidities. The composition of the kit may comprise at least one carrier, at least one binder, at least one diluent, at least one excipient, at least one other therapeutic agent, or mixtures thereof.

The methods for treating a clinical indication by the SERD compounds disclosed herein, may be effectuated by administering a therapeutically effective amount of the SERD to a patient in need thereof, this therapeutically effective amount may comprise administration of the prodrug to the patient at 1 mg/kg/day, 2 mg/kg/day, 3 mg/kg/day, 4 mg/kg/day, 5 mg/kg/day, 10 mg/kg/day, and 20 mg/kg/day. Alternatively, amounts ranging from about 0.001mg/kg/day to about 0.01 mg/kg/day, or about 0.01 mg/kg/day to about 0.1 mg/kg/day, or about 0.1 mg/kg/day to about 1 mg/kg/day, or about 1 mg/kg/day to 10 mg/kg/day, or about 10 mg/kg/day to about 100 mg/kg/day are also contemplated.

In certain aspects, the at least one SERD compound has a purity of ≥75%, ≥80%, ≥85%, ≥90%, ≥95%, ≥96%, ≥97%, or ≥98%, and preferably ≥99%.

One aspect of the present disclosure is the compounds disclosed herein as well as the intermediates as used for their synthesis.

While certain features of this invention shown and described below are pointed out in the annexed claims, the invention is not intended to be limited to the details specified, since a person of ordinary skill in the relevant art will understand that various omissions, modifications, substitutions, and changes in the forms and details of the invention illustrated and in its operation may be made without departing in any way from the spirit of the present invention. No feature of the invention is critical or essential unless it is expressly stated as being “critical” or “essential.”

These and other features, aspects, and advantages of embodiments of the present disclosure will become better understood with regard to the following descriptions, claims, and accompanying drawings explained below.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements.

FIG. 1 shows the general synthetic scheme for preparation of SERD 1.

FIG. 2 shows the general synthetic scheme for preparation of SERD 2.

FIG. 3 shows the general synthetic scheme for preparation of SERD 3.

FIG. 4 shows the general synthetic scheme for preparation of SERD 4.

FIG. 5 shows the general synthetic scheme for preparation of SERD 5.

FIG. 6 shows the general synthetic scheme for preparation of SERD 6.

FIG. 7 shows the general synthetic scheme for preparation of SERD 7.

FIG. 8 shows the general synthetic scheme for preparation of SERD 8.

FIG. 9 shows the general synthetic scheme for preparation of SERD 9.

FIG. 10 shows the general synthetic scheme for preparation of SERD 10.

FIG. 11 shows the antiestrogenic effects of representative SERDs in T47D-KBluc cells.

FIG. 12 shows the effects of representative SERDs in MCF-7 E3 proliferation assay.

FIG. 13 shows the effect of SERD 4 on estrogen receptor α (ERα) expression. Western blots showing ER protein expression in MCF-7 cells dramatically downregulated by GDC-810, SERD 4, and GW-7604, respectively, in a dose-dependent manner.

FIG. 14 shows the effect of SERD 9 on estrogen receptor α (ERα) expression. Western blots showing ER protein expression dramatically downregulated by A. Fulvestrant, B. SERD 9 in a dose-dependent manner.

FIG. 15 shows the binding of SERD 4 and SERD 9 to estrogen receptor α (ERα) with high affinity.

FIG. 16 shows the oral bioavailability of SERD 4 and GW7604 in rats after a single dose of 10 mg/kg per os (p.o.).

FIG. 17 shows the oral bioavailability of SERD 9 in mice after a single dose of 5 mg/kg PO

FIG. 18 shows the efficacy of SERD 9 in mice bearing breast tumor xenograft when orally administered at two doses, as compared to that of fulvestrant administered by subcutaneous injection.

### DETAILED DESCRIPTION

Before the subject disclosure is further described, it is to be understood that the disclosure is not limited to the particular embodiments of the disclosure described below, as variations of the particular embodiments may be made and still fall within the scope of the appended claims. It is also to be understood that the terminology employed is for the purpose of describing particular embodiments, and is not intended to be limiting. Instead, the scope of the present disclosure will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this disclosure belongs.

As used herein, the term “minimize” or “reduce”, or derivatives thereof, include a complete or partial inhibition of a specified biological effect (which is apparent from the context in which the terms “minimize” or “reduce” are used).

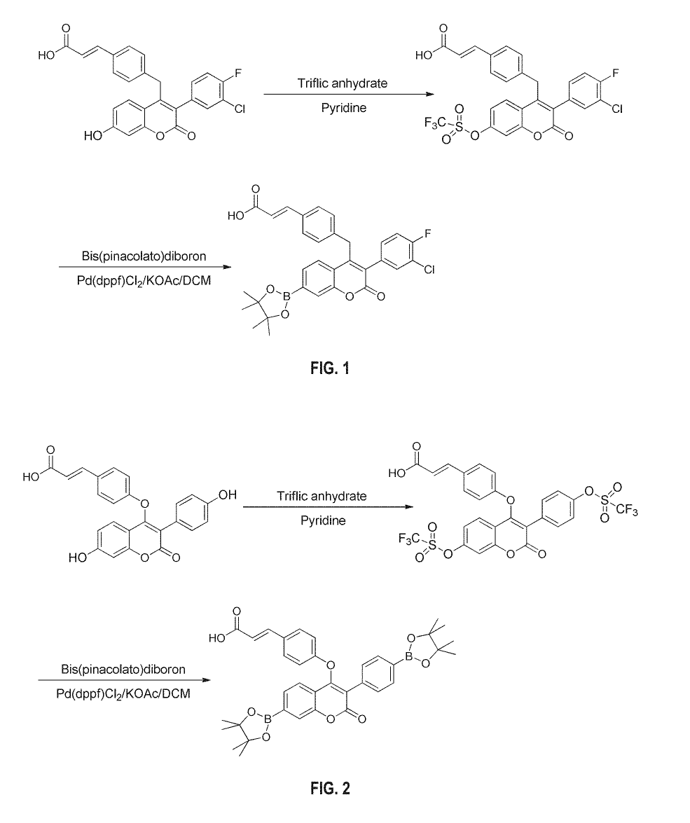

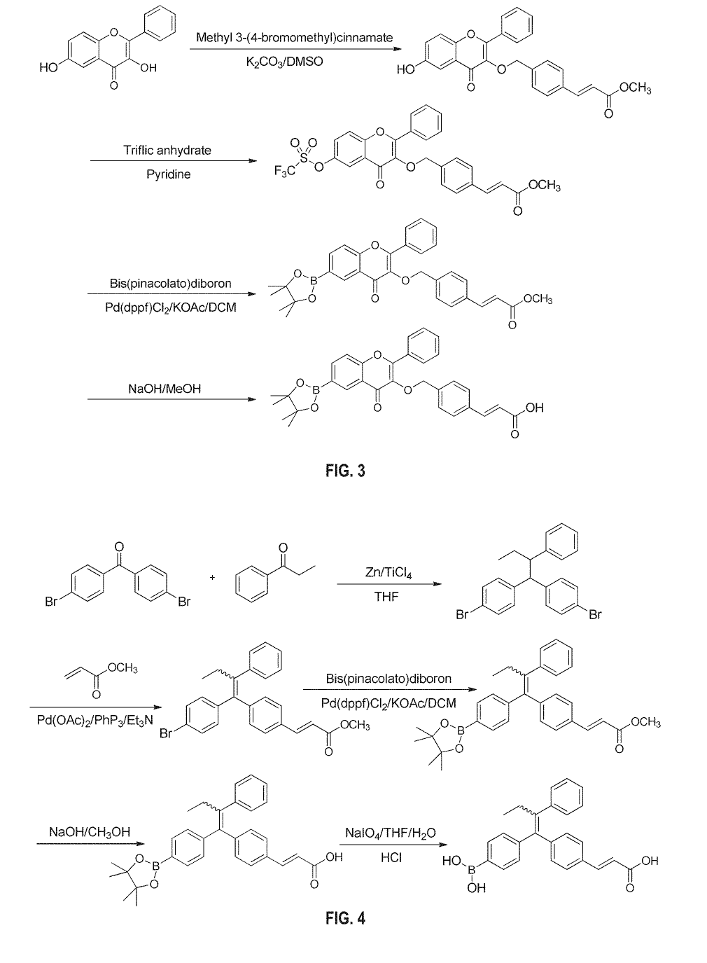

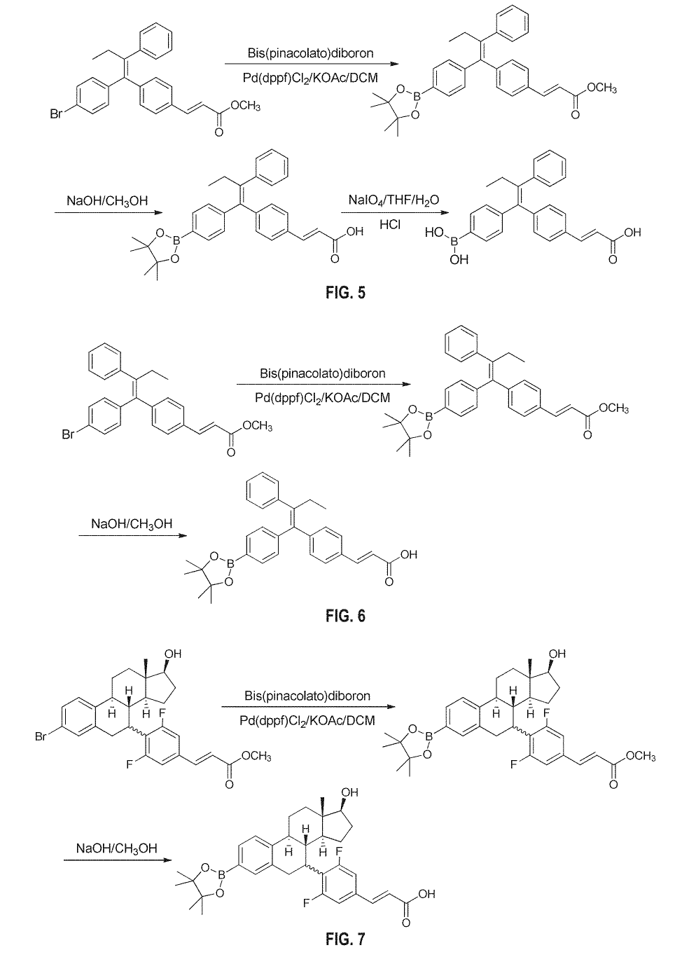

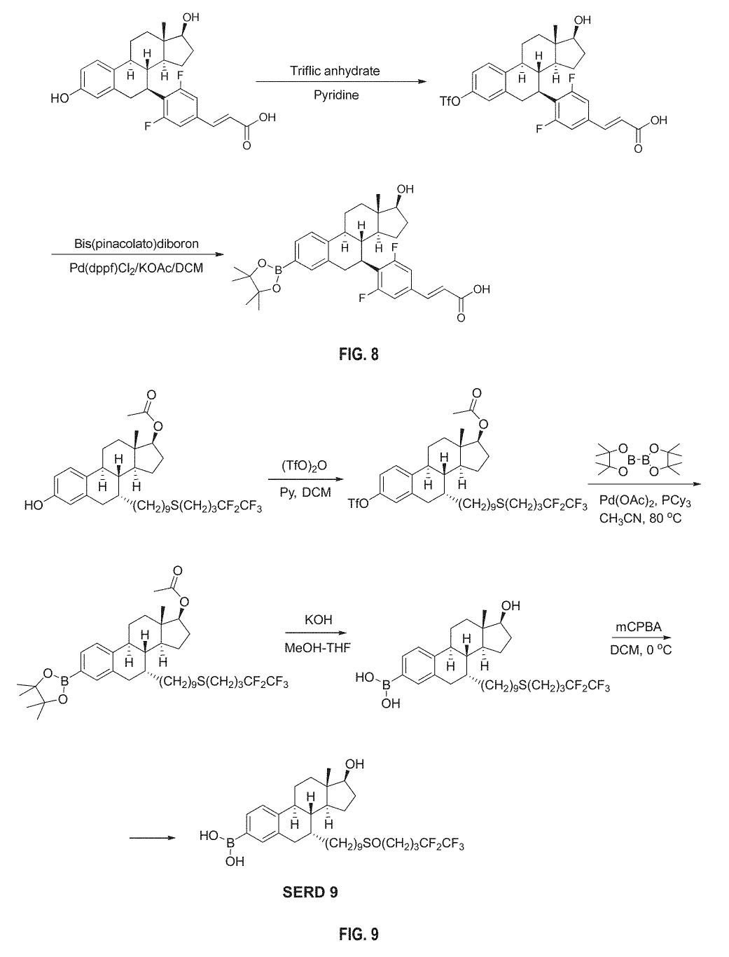

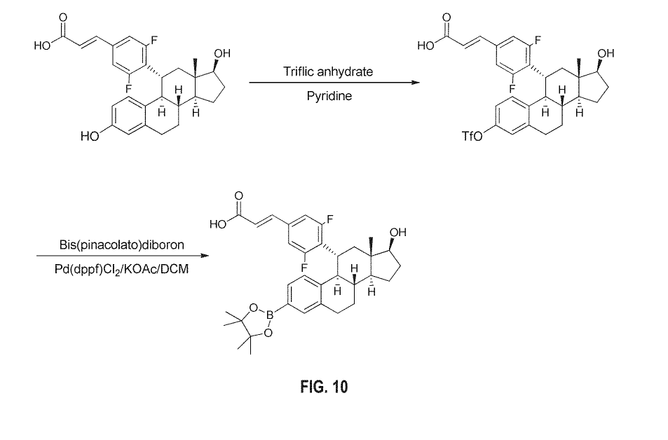

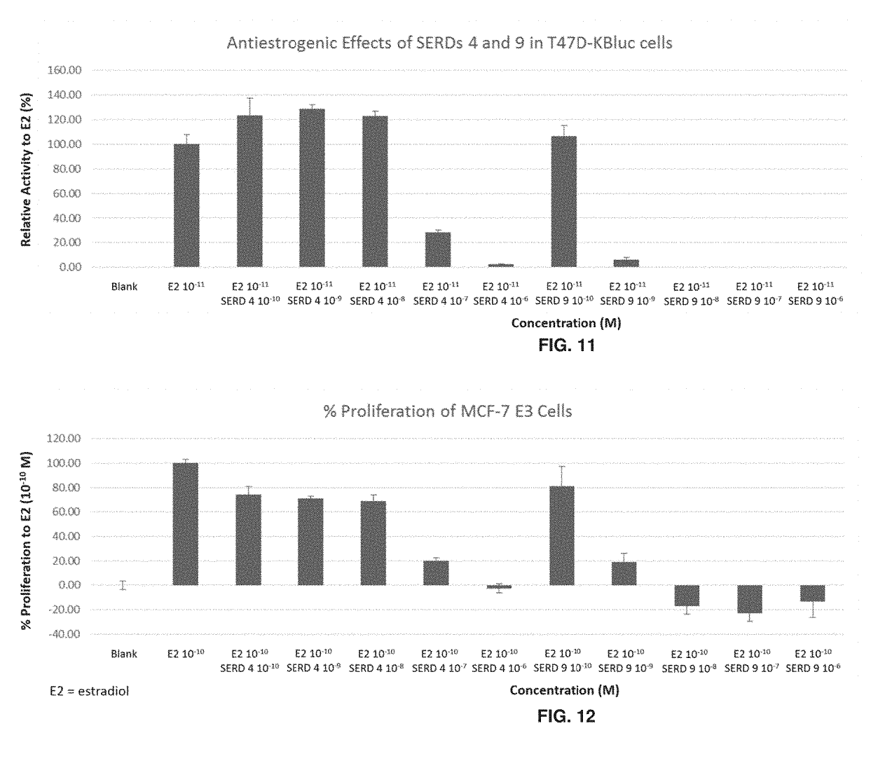

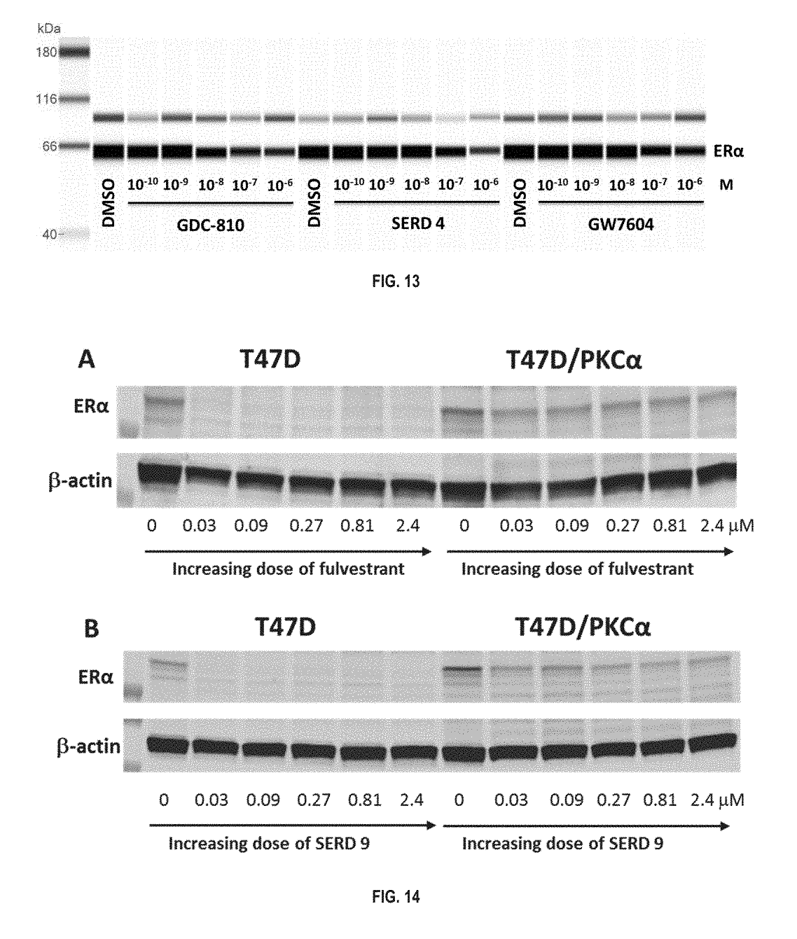

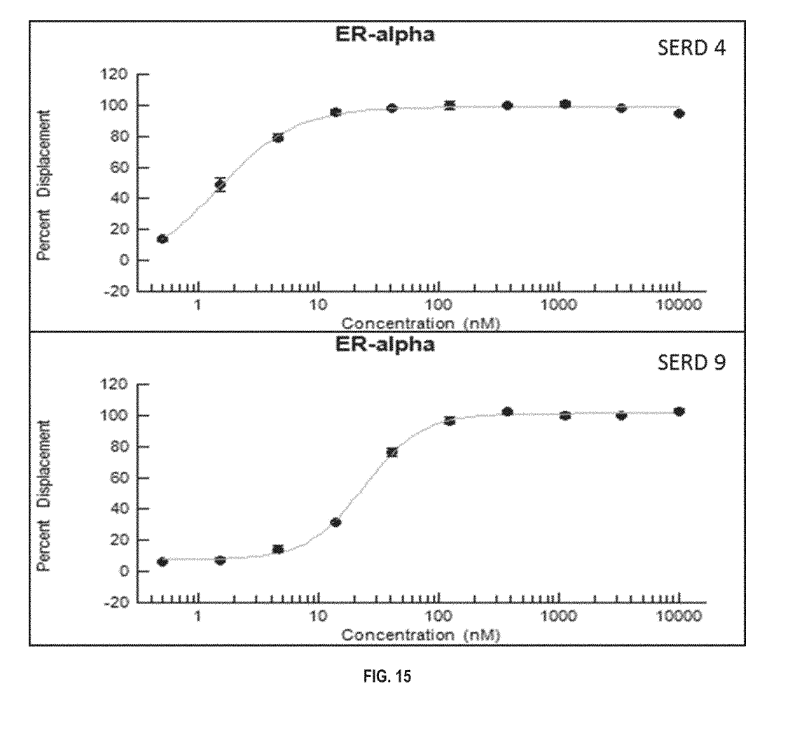

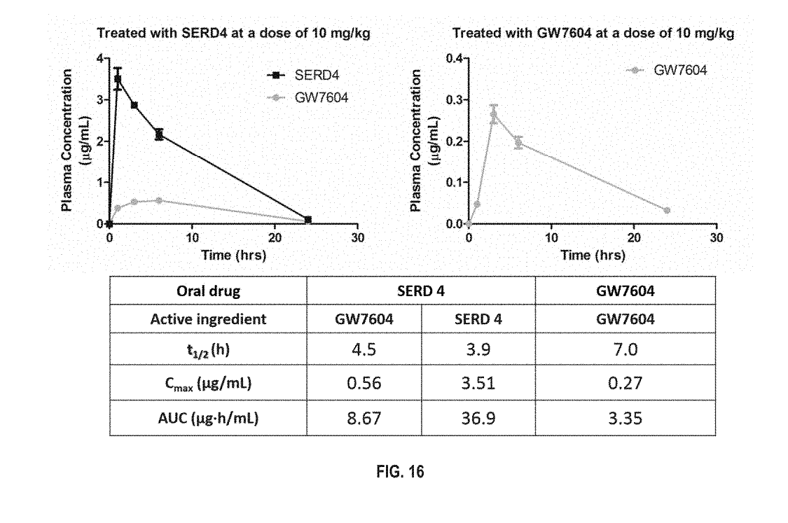

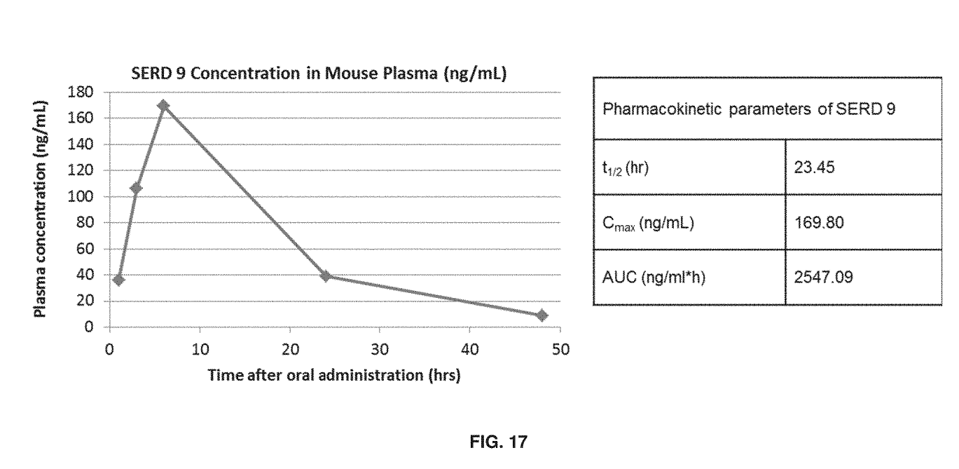

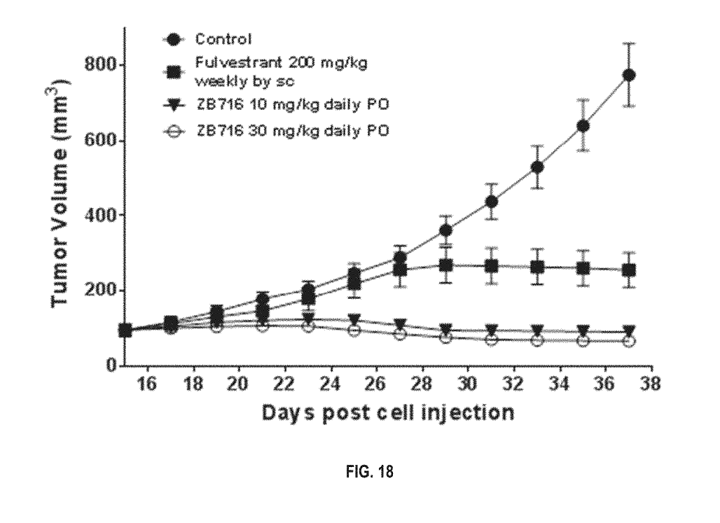

The compounds according to the disclosure can be prepared according to the schemes shown in FIGS. 1-10,

Table 1 below shows the cytotoxicity of the representative SERDs in various breast cancer cell lines.

| | MCF-7 | MCF-7/TamR | T47D/PKCα | BT474 |
|---|---|---|---|---|
| | IC₅₀ (μM) | | | |
| 4-Hydroxytamoxifen | 0.0033 | 21.1 | 0.54 | 1.43 |
| SERD 4 | 1.8 | 1.2 | Not tested | Not |
| | | | | tested |
| SERD 6 | 7.73 | 4.53 | 6.54 | 80.5 |
| SERD 9 | 0.0032 | 0.044 | 0.37 | 0.39 |

The compounds according to the disclosure are isolated and purified in a manner known per se, e.g. by distilling off the solvent in vacuo and recrystallizing the residue obtained from a suitable solvent or subjecting it to one of the customary purification methods, such as chromatography on a suitable support material. Furthermore, reverse phase preparative HPLC of compounds of the present disclosure which possess a sufficiently basic or acidic functionality, may result in the formation of a salt, such as, in the case of a compound of the present disclosure which is sufficiently basic, a trifluoroacetate or formate salt for example, or, in the case of a compound of the present disclosure which is sufficiently acidic, an ammonium salt for example. Salts of this type can either be transformed into its free base or free acid form, respectively, by various methods known to the person skilled in the art, or be used as salts in subsequent biological assays. Additionally, the drying process during the isolation of compounds of the present disclosure may not fully remove traces of cosolvents, especially such as formic acid or trifluoroacetic acid, to give solvates or inclusion complexes. The person skilled in the art will recognize which solvates or inclusion complexes are acceptable to be used in subsequent biological assays. It is to be understood that the specific form (e.g., salt, free base, solvate, inclusion complex) of a compound of the present disclosure as isolated as described herein is not necessarily the only form in which said compound can be applied to a biological assay in order to quantify the specific biological activity.

Salts of the compounds of formulas (I) through (X) according to the disclosure can be obtained by dissolving the free compound in a suitable solvent (for example a ketone such as acetone, methylethylketone or methylisobutylketone, an ether such as diethyl ether, tetrahydrofuran or dioxane, a chlorinated hydrocarbon such as methylene chloride or chloroform, or a low molecular weight aliphatic alcohol such as methanol, ethanol or isopropanol) which contains the desired acid or base, or to which the desired acid or base is then added. The acid or base can be employed in salt preparation, depending on whether a mono- or polybasic acid or base is concerned and depending on which salt is desired, in an equimolar quantitative ratio or one differing therefrom. The salts are obtained by filtering, reprecipitating, precipitating with a non-solvent for the salt or by evaporating the solvent. Salts obtained can be converted into the free compounds which, in turn, can be converted into salts. In this manner, pharmaceutically unacceptable salts, which can be obtained, for example, as process products in the manufacturing on an industrial scale, can be converted into pharmaceutically acceptable salts by processes known to the person skilled in the art.

All references cited in this specification are herein incorporated by reference as though each reference was specifically and individually indicated to be incorporated by reference. The citation of any reference is for its disclosure prior to the filing date and should not be construed as an admission that the present disclosure is not entitled to antedate such reference by virtue of prior invention.

It will be understood that each of the elements described above, or two or more together may also find a useful application in other types of methods differing from the type described above. Without further analysis, the foregoing will so fully reveal the gist of the present disclosure that others can, by applying current knowledge, readily adapt it for various applications without omitting features that, from the standpoint of prior art, fairly constitute essential characteristics of the generic or specific aspects of this disclosure set forth in the appended claims. The foregoing embodiments are presented by way of example only; the scope of the present disclosure is to be limited only by the following claims.

### REFERENCES CITED

1. Jasani B, Douglas-Jones A, Rhodes A, Wozniak S, Barrett-Lee P J, Gee J, Nicholson R. Measurement of estrogen receptor status by immunocytochemistry in paraffin wax sections. Methods Mol Med. 2006; 120:127-46.
2. Setiawan V W, Monroe K R, Wilkens L R, Kolonel L N, Pike M C, Henderson B E. Breast cancer risk factors defined by estrogen and progesterone receptor status: the multiethnic cohort study. Am J Epidemiol. 2009 May 15; 169(10):1251-9.
3. Barrios C, Forbes J F, Jonat W, Conte P, Gradishar W, Buzdar A, Gelmon K, Gnant M, Bonneterre J, Toi M, Hudis C, Robertson J F. The sequential use of endocrine treatment for advanced breast cancer: where are we? Ann Oncol. 2012, 23(6):1378-86.
4. Nabholtz J M, Buzdar A, Pollak M et al. Anastrozole is superior to tamoxifen as first-line therapy for advanced breast cancer in postmenopausal women: results of a North American multicenter randomized trial. Arimidex Study Group. J Clin Oncol 2000; 18: 3758-3767
5. Nabholtz J M, Bonneterre J, Buzdar A et al. Anastrozole (Arimidex) versus tamoxifen as first-line therapy for advanced breast cancer in postmenopausal women: survival analysis and updated safety results. Eur J Cancer 2003; 39: 1684-1689.
6. Morris C, Wakeling A. Fulvestrant (‘Faslodex’)—a new treatment option for patients progressing on prior endocrine therapy. Endocr Relat Cancer. 2002 Dec; 9(4):267-76.
7. Robertson J F, Lindemann J, Garnett S, Anderson E, Nicholson R I, Kuter I, Gee J M. A good drug made better: the fulvestrant dose-response story. Clin Breast Cancer. 2014, Dec; 14(6):381-9.
8. Robertson J F. Fulvestrant (Faslodex)—how to make a good drug better. Oncologist. 2007 Jul; 12(7):774-84.
9. Ohno S, Rai Y, Iwata H, Yamamoto N, Yoshida M, Iwase H, Masuda N, Nakamura S, Taniguchi H, Kamigaki S, Noguchi S. Three dose regimens of fulvestrant in postmenopausal Japanese women with advanced breast cancer: results from a double-blind, phase II comparative study (FINDER1). Ann Oncol. 2010, 21(12):2342-7.
10. Pritchard K I, Rolski J, Papai Z, Mauriac L, Cardoso F, Chang J, Panasci L, Ianuli C, Kahan Z, Fukase K, Lindemann J P, Macpherson M P, Neven P. Results of a phase II study comparing three dosing regimens of fulvestrant in postmenopausal women with advanced breast cancer (FINDER2). Breast Cancer Res Treat. 2010 Sep; 123(2):453-61.
11. NCT01823835, A Study of ARN-810 (GDC-0810) in Postmenopausal Women With Locally Advanced or Metastatic Estrogen Receptor Positive Breast Cancer, 2013, http:/clinicaltrials.gov
12. NCT02248090, AZD9496 First Time in Patients Ascending Dose Study, 2014, http:/clinicaltrials.gov

1. At least one compound selected from the group consisting of Formula (I) through Formula (X).

2. The at least one compound of claim 1 for use in the treatment of a proliferative disease in a mammal in need thereof.

3. The at least one compound of claim 1 for use in the treatment of a cancer in a mammal in need thereof.

4. The at least one compound of claim 1 for use in modulating an estrogen receptor in a mammal in need thereof.

5. A composition comprising the at least one compound of claim 1 for use as a medicament.

6. The at least one compound of claim 1, wherein said compound is a structure of Formula (I): 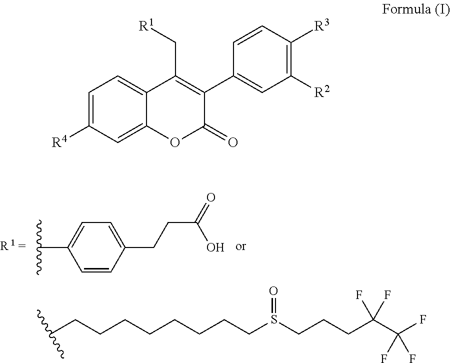
R²=H, OH, Me, Cl, F, CF₃
R³=H, OH, OMe, F, CF₃, OCF₃, Cl, Br, (HO)₂B, KF₃B, NaF₃B, 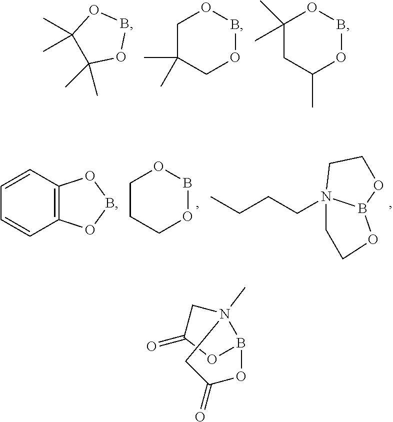
wherein the R³ substituent point of attachment is on the substituent boron atom of R³,
R⁴=H, OH, OMe, F, CF₃, OCF₃, Cl, Br, (HO)₂B, KF₃B, NaF₃B, 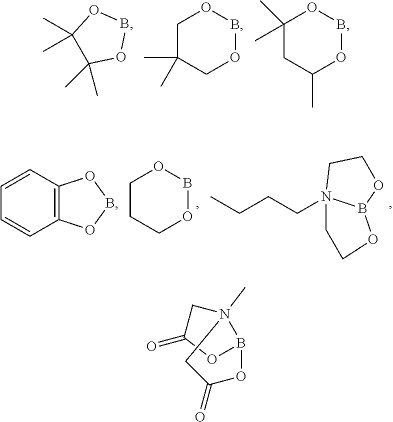
and wherein the R⁴ substituent point of attachment is on the substituent boron atom of R⁴.

7. The at least one compound of claim 1, wherein said compound is a structure of Formula (II): 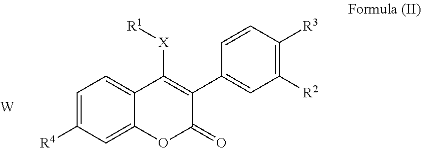
X=O, S, NH, OCH₂, SCH₂, NHCH₂, CH₂O, CH₂S, or CH₂NH₂ 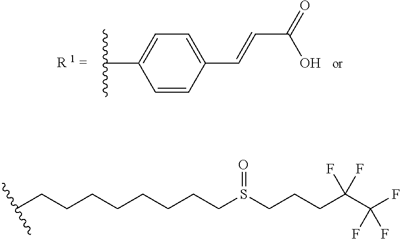 [SMILES: *c1ccc(/C=C/C(=O)O)cc1 ; "or" ; *CCCCCCCCS(=O)CCCC(F)(F)C(F)(F)F]
R²=H, OH, Me, Cl, F, CF₃
R³=H, OH, OMe, F, CF₃, OCF₃, Cl, Br, (HO)₂B, KF₃B, NaF₃B, 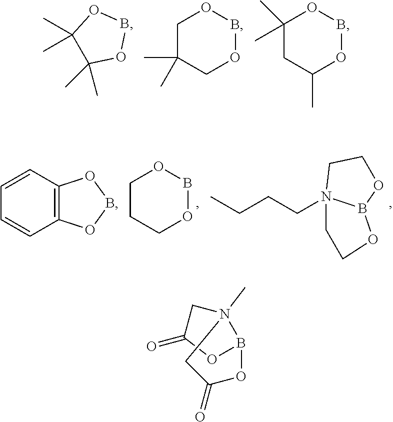
herein the R³ substituent point of attachment is on the substituent boron atom of R³,
R⁴=H, OH, OMe, F, CF₃, OCF₃, Cl, Br, (HO)₂B, KF₃B, NaF₃B, 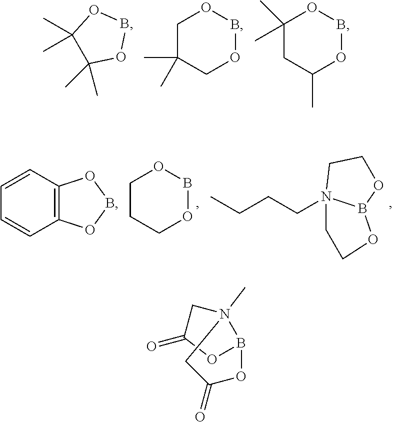
and wherein the R⁴ substituent point of attachment is on the substituent boron atom of R⁴.

8. The at least one compound of claim 1, wherein said compound is a structure of Formula (III): 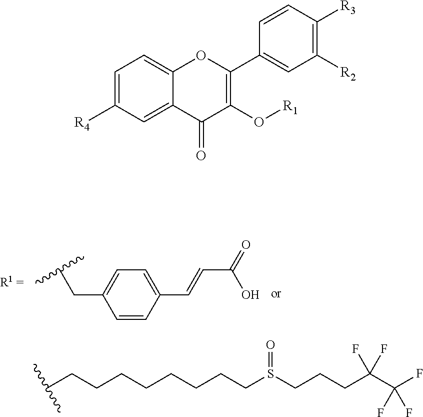
R²=H, OH, Me, Cl, F, CF₃
R³=H, OH, OMe, F, CF₃, OCF₃, Cl, Br, (HO)₂B, KF₃B, NaF₃B, 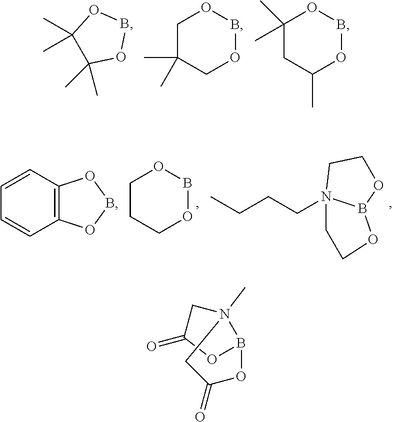
wherein the R³ substituent point of attachment is on the substituent boron atom of R³,
R⁴=H, OH, OMe, F, CF₃, OCF₃, Cl, Br, (HO)₂B, KF₃B, NaF₃B, 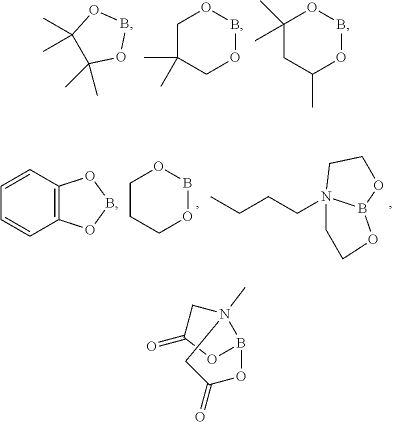
and wherein the R⁴ substituent point of attachment is on the substituent boron atom of R⁴.

9. The at least one compound of claim 1, wherein said compound is a structure of Formula (IV): 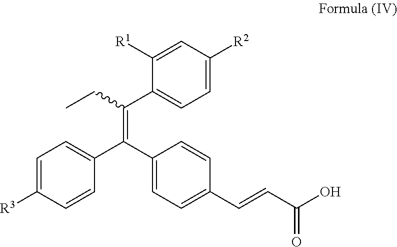
R¹=H, OH, OMe, Me, Cl, F, CF₃
R²=H, OH, OMe, Me, Cl, F, CF₃
R³=H, OH, OMe, F, CF₃, OCF₃, Cl, Br, (HO)₂B, KF₃B, NaF₃B, 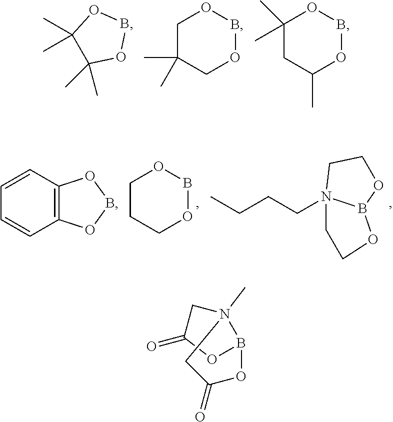
wherein the R³ substituent point of attachment is on the substituent boron atom of R³.

10. The at least one compound of claim 1, wherein said compound is a structure of Formula (V): 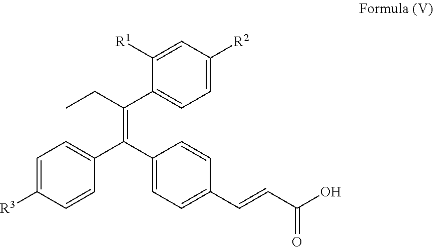
R¹=H, OH, OMe, Me, Cl, F, CF₃
R²=H, OH, OMe, Me, Cl, F, CF₃
R³=H, OH, OMe, F, CF₃, OCF₃, Cl, Br, (HO)₂B, KF₃B, NaF₃B, 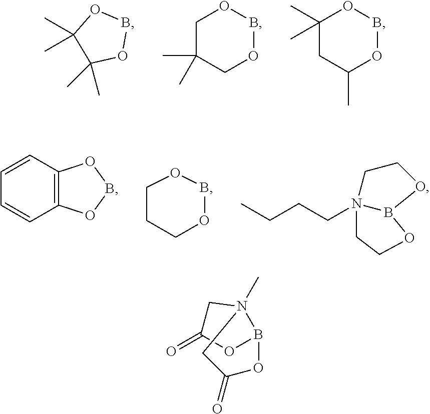
wherein the R³ substituent point of attachment is on the substituent boron atom of R³.

11. The at least one compound of claim 1, wherein said compound is a structure of Formula (VI): 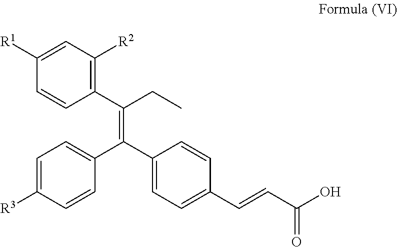
R¹=H, OH, OMe, Me, Cl, F, CF₃
R²=H, OH, OMe, Me, Cl, F, CF₃
R³=H, OH, OMe, F, CF₃, OCF₃, Cl, Br, (HO)₂B, KF₃B, NaF₃B, 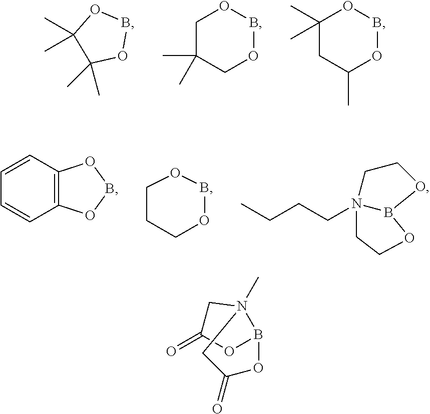
wherein the R³ substituent point of attachment is on the substituent boron atom of R³.

12. The at least one compound of claim 1, wherein said compound is a structure of Formula (VII): 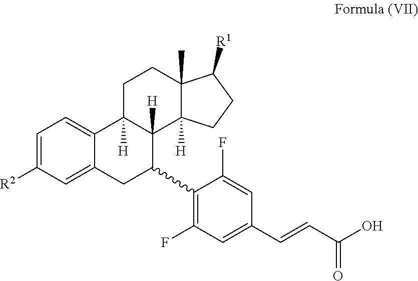
R¹=H, OH, OMe, F, CF₃, OCF₃, Cl, Br, (HO)₂B, KF₃B, NaF₃B, 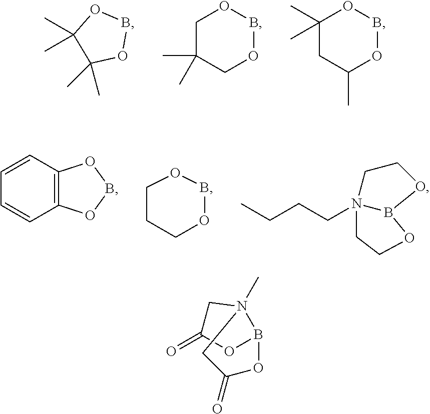
wherein the R¹ substituent point of attachment is on the substituent boron atom of R¹,
R²=H, OH, OMe, F, CF₃, OCF₃, Cl, Br, (HO)₂B, KF₃B, NaF₃B, 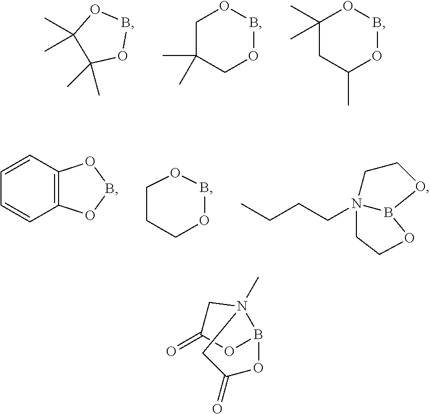
and wherein the R² substituent point of attachment is on the substituent boron atom of R².

13. The at least one compound of claim 1, wherein said compound is a structure of Formula (VIII): 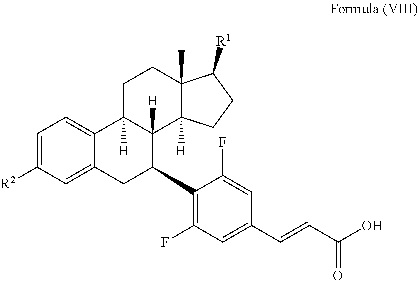
R¹=H, OH, OMe, F, CF₃, OCF₃, Cl, Br, (HO)₂B, KF₃B, NaF₃B, 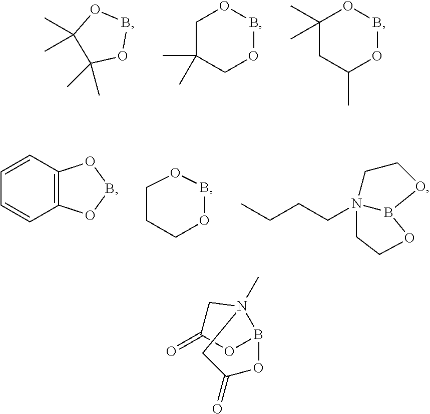
wherein the R¹ substituent point of attachment is on the substituent boron atom of R¹,
R²=H, OH, OMe, F, CF₃, OCF₃, Cl, Br, (HO)₂B, KF₃B, NaF₃B, 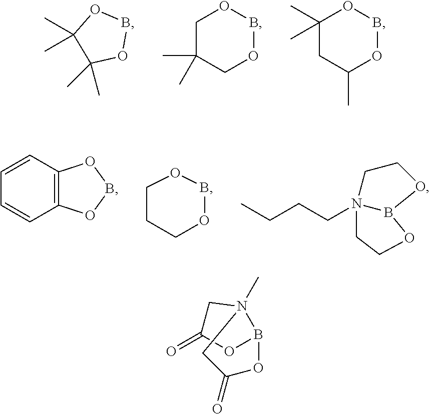
and wherein the R² substituent point of attachment is on the substituent boron atom of R².

14. The at least one compound of claim 1, wherein said compound is a structure of Formula (IX): 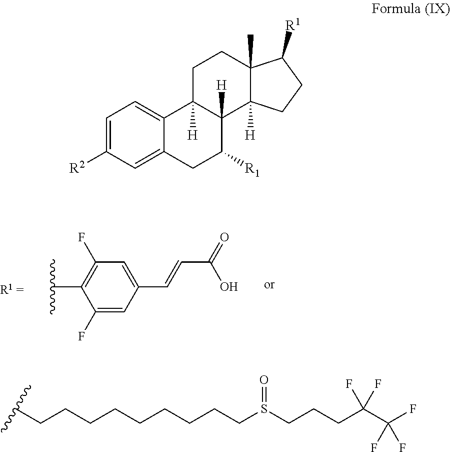
R²=H, OH, OMe, F, CF₃, OCF₃, Cl, Br, (HO)₂B, KF₃B, NaF₃B, 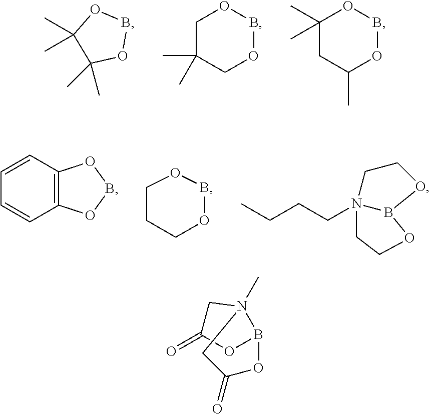
wherein the R² substituent point of attachment is on the substituent boron atom of R².
R³=H, OH, OMe, F, CF₃, OCF₃, Cl, Br, (HO)₂B, KF₃B, NaF₃B, 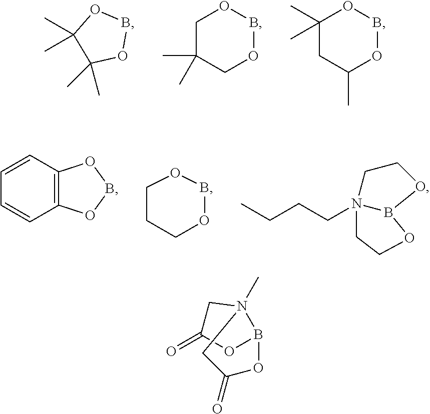
and wherein the R³ substituent point of attachment is on the substituent boron atom of R³.

15. The at least one compound of claim 1, wherein said compound is a structure of Formula (X): 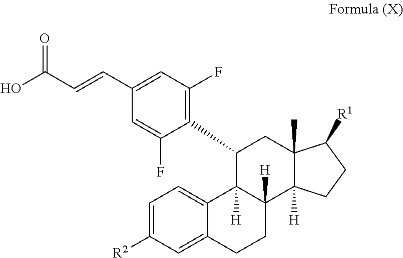
R¹=H, OH, OMe, F, CF₃, OCF₃, Cl, Br, (HO)₂B, KF₃B, NaF₃B, 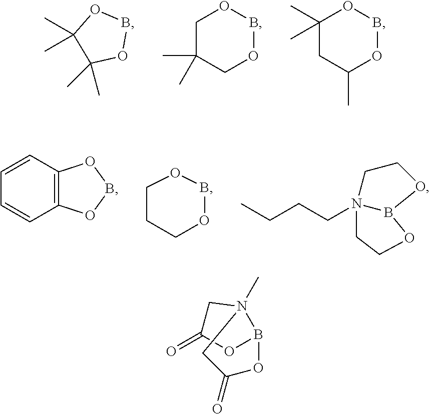
wherein the R¹ substituent point of attachment is on the substituent boron atom of R¹.
R²=H, OH, OMe, F, CF₃, OCF₃, Cl, Br, (HO)₂B, KF₃B, NaF₃B, 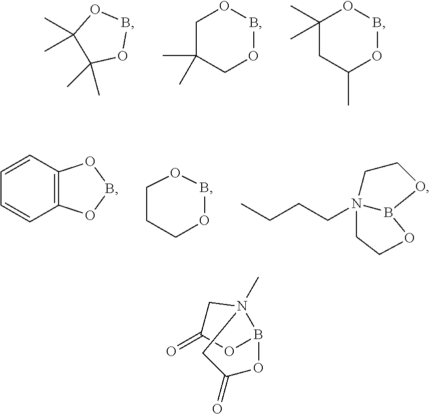
and wherein the R² substituent point of attachment is on the substituent boron atom of R².
